(19) United States
(12) Patent Application Publication
(10) Pub. No.: US 2023/0124176 A1
(43) Pub. Date: Apr. 20, 2023

(54) PATENT SEARCH SYSTEM AND METHOD THEREOF

(71) Applicant: KKLAB TECHNOLOGIES PTE. LTD., Taipei City (TW)

(72) Inventors: Shih Chun Lu, Taipei City (TW); Shih Hung Lin, Taipei City (TW); Sheng Fu Lin, Taipei City (TW)

(73) Assignee: KKLAB TECHNOLOGIES PTE. LTD., Taipei City (TW)

(21) Appl. No.: 17/720,712

(22) Filed: Apr. 14, 2022

(30) Foreign Application Priority Data
Oct. 14, 2021 (TW) 110138227

(51) Int. Cl. G06F 16/38; G06F 16/33

(52) U.S. Cl. CPC G06F 16/38; G06F 16/3331; G06F 2216/11

(57) ABSTRACT

A patent search system, comprising: a database storing a plurality of first patent document data items; and a server accessing the database, the server receiving a first search criterion instruction and then retrieving a plurality of second patent document data items from the plurality of first patent document data items based on the first search criterion instruction, wherein the server receives a first selection instruction associated with a first selected patent document data item in the plurality of second patent document data items, obtains a first keyword data item from the first selected patent document data item based on the first selection instruction, and generates a second search criterion instruction at least based on the first search criterion instruction and the first keyword data item, the second search criterion instruction comprising the first keyword data item, wherein the server retrieves a plurality of third patent document data items from the plurality of first patent document data items based on the second search criterion instruction, wherein the first search criterion instruction indicates a first search criterion, and the server retrieves the plurality of second patent document data items from the plurality of first patent document data items on the basis that the plurality of second patent document data items all meet the first search criterion, and wherein the second search criterion instruction indicates a second search criterion, and the server retrieves the plurality of third patent document data items from the plurality of first patent document data items on the basis that the plurality of third patent document data items all meet the second search criterion.

This application claims priority under 35 U.S.C. § 119 to Taiwanese Patent Application No. 110138227, filed Oct. 14, 2021, the entirety of which is incorporated by reference herein.

### TECHNICAL FIELD

The present invention relates to a patent search system and a method thereof, and more particularly to a patent search system and a patent search method for the system that may assist users in patent searches based on selection instructions.

### BACKGROUND

A patent search system is a type of search system specifically used for searching patent documents. Since the contents of patent documents contain professional knowledge of various fields, and since the writing style and format of patent documents are different to those of ordinary documents, in most cases, ordinary users would not know how to conduct patent searches properly or could otherwise have problems finding the precise group of patents being targeted, unless they have acquired certain knowledge of the patent system or have a certain degree of understanding of the technical field to which the target patents (i.e., the group of patents they try to search for) pertain. In addition, as described above, since the contents, writing style and format of patent documents are different to those of ordinary documents, a general-purpose search system (such as Google and the like) are not suitable tools for patent searches. In this light, it is needed to have a patent search system and a patent search method for the system that can assist ordinary users (those who have not acquired patent knowledge) in patent searches.

### SUMMARY

To solve the problems described above, one idea of the present invention is to provide a patent search system and a method for the system that may assist users in patent searches. Another idea of the present invention is to provide a patent search system and a method for the system that may assist users in patent searches based on selection instructions.

Based on the idea described above, the present invention provides a patent search system, comprising: a database storing a plurality of first patent document data items; and a server accessing the database, the server receiving a first search criterion instruction and then retrieving a plurality of second patent document data items from the plurality of first patent document data items based on the first search criterion instruction, wherein the server receives a first selection instruction associated with a first selected patent document data item in the plurality of second patent document data items, obtains a first keyword data item from the first selected patent document data item based on the first selection instruction, and generates a second search criterion instruction at least based on the first search criterion instruction and the first keyword data item, the second search criterion instruction comprising the first keyword data item, wherein the server retrieves a plurality of third patent document data items from the plurality of first patent document data items based on the second search criterion instruction, wherein the first search criterion instruction indicates a first search criterion, and the server retrieves the plurality of second patent document data items from the plurality of first patent document data items on the basis that the plurality of second patent document data items all meet the first search criterion, and wherein the second search criterion instruction indicates a second search criterion, and the server retrieves the plurality of third patent document data items from the plurality of first patent document data items on the basis that the plurality of third patent document data items all meet the second search criterion.

In a preferred embodiment of the present invention, the first search criterion instruction comprises an initial keyword data item, and the server retrieves the plurality of second patent document data items and a plurality of fourth patent document data items from the plurality of first patent document data items based on the first search criterion instruction, wherein each of the plurality of second patent document data items comprises an invention title data item, an abstract data item, and a patent claims data item, and one of the invention title data item, the abstract data item, and the patent claims data item corresponding to each of the plurality of second patent document data items comprises the initial keyword data item, and wherein the plurality of fourth patent document data items all comprise the initial keyword data item.

In a preferred embodiment of the present invention, the first selection instruction is associated with a related-tag data item, and each of the plurality of third patent document data items comprises the first keyword data item.

In a preferred embodiment of the present invention, the first selected patent document data item comprises a patent classification data item, and the first selection instruction is associated with a related-tag data item, wherein the server generates a second search criterion instruction at least based on the first search criterion instruction, the first keyword data item, and the patent classification data item, the second search criterion instruction comprising the patent classification data item, and wherein the plurality of third patent document data items all comprise the first keyword data item and the patent classification data item.

In a preferred embodiment of the present invention, prior to retrieving the plurality of third patent document data items, the server deletes the first keyword data item from the second search criterion instruction based on a deletion instruction.

In a preferred embodiment of the present invention, the server receives a second selection instruction associated with a second selected patent document data item in the plurality of second patent document data items, and obtains a second keyword data item from the second selected patent document data item based on the second selection instruction, the second keyword data item being identical to the first keyword data item, wherein the server generates the second search criterion instruction at least based on the first search criterion instruction, the first keyword data item, and the second keyword data item, and the server generates the second search criterion instruction at least on the basis that the first keyword data item is identical to the second keyword data item, and wherein the first selection instruction and the second selection instruction are both associated with a related-tag data item, and the plurality of third patent document data items all comprise the first keyword data item.

In a preferred embodiment of the present invention, the server receives a third selection instruction associated with a third selected patent document data item in the plurality of second patent document data items, the third selected patent document data item not comprising the first keyword data item, wherein the first selection instruction is associated with an unrelated-tag data item, and the third selection instruction is associated with a related-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, and wherein none of the plurality of third patent document data item comprises the first keyword data item.

In a preferred embodiment of the present invention the server receives a third selection instruction associated with a third selected patent document data item in the plurality of second patent document data items, the third selected patent document data item not comprising the first keyword data item, wherein the first selection instruction is associated with an unrelated-tag data item, and the third selection instruction is associated with a related-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, wherein none of the plurality of third patent document data item comprises the first keyword data item, wherein the server receives a fourth selection instruction associated with a fourth selected patent document data item in the plurality of second patent document data items, and obtains a fourth keyword data item from the fourth selected patent document data item based on the fourth selection instruction, the fourth keyword data item being identical to the first keyword data item, wherein the fourth selection instruction is associated with the unrelated-tag data item, and wherein the server generates the second search criterion instruction at least on the basis that the fourth selection instruction is associated with the unrelated-tag data item, and that the fourth keyword data item is identical to the first keyword data item.

In a preferred embodiment of the present invention, the server receives a third selection instruction associated with a third selected patent document data item in the plurality of second patent document data items, the third selected patent document data item not comprising the first keyword data item, wherein the first selection instruction is associated with an unrelated-tag data item, and the third selection instruction is associated with a related-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, wherein none of the plurality of third patent document data item comprises the first keyword data item, wherein the server receives a fourth selection instruction associated with a fourth selected patent document data item in the plurality of second patent document data items, and obtains a fourth keyword data item from the fourth selected patent document data item based on the fourth selection instruction, the fourth keyword data item being identical to the first keyword data item, wherein the fourth selection instruction is associated with the unrelated-tag data item, wherein the server generates the second search criterion instruction at least on the basis that the fourth selection instruction is associated with the unrelated-tag data item, and that the fourth keyword data item is identical to the first keyword data item, wherein the server receives a fifth selection instruction associated with a fifth selected patent document data item in the plurality of second patent document data items, the fifth selected patent document data item not comprising the first keyword data item, wherein the fifth selection instruction is associated with the related-tag data item, and wherein the server generates the second search criterion instruction at least on the basis that the fifth selection instruction is associated with the related-tag data item, and that the fifth selected patent document data item does not comprise the first keyword data item.

According to an objective of the present invention, a patent search method for use in a patent search system is provided, the patent search system comprising a database and a server, the database storing a plurality of first patent document data items, the server accessing the database, the patent search method comprising the steps of: receiving, by the server, a first search criterion instruction and retrieving a plurality of second patent document data items from the plurality of first patent document data items based on the first search criterion instruction; receiving, by the server, a first selection instruction associated with a first selected patent document data item in the plurality of second patent document data items; obtaining, by the server, a first keyword data item from the first selected patent document data item based on the first selection instruction; generating, by the server, a second search criterion instruction at least based on the first search criterion instruction and the first keyword data item, the second search criterion instruction comprising the first keyword data item; and retrieving, by the server, a plurality of third patent document data items from the plurality of first patent document data items based on the second search criterion instruction, wherein the first search criterion instruction indicates a first search criterion, and the server retrieves the plurality of second patent document data items from the plurality of first patent document data items on the basis that the plurality of second patent document data items all meet the first search criterion, and wherein the second search criterion instruction indicates a second search criterion, and the server retrieves the plurality of third patent document data items from the plurality of first patent document data items on the basis that the plurality of third patent document data items all meet the second search criterion.

In a preferred embodiment of the present invention, the first search criterion instruction comprises an initial keyword data item, and the server retrieves the plurality of second patent document data items and a plurality of fourth patent document data items from the plurality of first patent document data items based on the first search criterion instruction, wherein each of the plurality of second patent document data items comprises an invention title data item, an abstract data item, and a patent claims data item, and one of the invention title data item, the abstract data item, and the patent claims data item corresponding to each of the plurality of second patent document data items comprises the initial keyword data item, and wherein the plurality of fourth patent document data items all comprise the initial keyword data item.

In a preferred embodiment of the present invention, the first selection instruction is associated with a related-tag data item, and the plurality of third patent document data items all comprise the first keyword data item.

In a preferred embodiment of the present invention, the first selected patent document data item comprises a patent classification data item, and the first selection instruction is associated with a related-tag data item, wherein the server generates a second search criterion instruction at least based on the first search criterion instruction, the first keyword data item, and the patent classification data item, and the second search criterion instruction comprises the patent classification data item, and wherein the plurality of third patent document data items all comprise the first keyword data item and the patent classification data item.

In a preferred embodiment of the present invention, the patent search method further comprises: deleting, by the server, the first keyword data item from the second search criterion instruction based on a deletion instruction prior to retrieving the plurality of third patent document data items.

In a preferred embodiment of the present invention, the patent search method further comprises: receiving, by the server, a second selection instruction associated with a second selected patent document data item in the plurality of second patent document data items; and obtaining, by the server, a second keyword data item from the second selected patent document data item based on the second selection instruction, the second keyword data item being identical to the first keyword data item, wherein the server generates the second search criterion instruction at least based on the first search criterion instruction, the first keyword data item, and the second keyword data item, and the server generates the second search criterion instruction at least on the basis that the first keyword data item is identical to the second keyword data item, and wherein the first selection instruction and the second selection instruction are both associated with a related-tag data item, and the plurality of third patent document data items all comprise the first keyword data item.

In a preferred embodiment of the present invention, the patent search method further comprises: receiving, by the server, a third selection instruction associated with a third selected patent document data item in the plurality of second patent document data items, the third selected patent document data item not comprising the first keyword data item, wherein the first selection instruction is associated with an unrelated-tag data item, and the third selection instruction is associated with a related-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, and wherein none of the plurality of third patent document data items comprises the first keyword data item.

In a preferred embodiment of the present invention, the patent search method further comprises: receiving, by the server, a third selection instruction associated with a third selected patent document data item in the plurality of second patent document data items, the third selected patent document data item not comprising the first keyword data item; receiving, by the server, a fourth selection instruction associated with a fourth selected patent document data item in the plurality of second patent document data items; and obtaining, by the server, a fourth keyword data item from the fourth selected patent document data item based on the fourth selection instruction, the fourth keyword data item being identical to the first keyword data item, wherein the first selection instruction is associated with an unrelated-tag data item, and the third selection instruction is associated with a related-tag data item, wherein the fourth selection instruction is associated with the unrelated-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, wherein the server generates the second search criterion instruction at least on the basis that the fourth selection instruction is associated with the unrelated-tag data item, and that the fourth keyword data item is identical to the first keyword data item, and wherein none of the plurality of third patent document data items comprises the first keyword data item.

In a preferred embodiment of the present invention, the patent search method further comprises: receiving, by the server, a third selection instruction associated with a third selected patent document data item in the plurality of second patent document data items, the third selected patent document data item not comprising the first keyword data item; receiving, by the server, a fourth selection instruction associated with a fourth selected patent document data item in the plurality of second patent document data items; obtaining, by the server, a fourth keyword data item from the fourth selected patent document data item based on the fourth selection instruction, the fourth keyword data item being identical to the first keyword data item; and receiving, by the server, a fifth selection instruction associated with a fifth selected patent document data item in the plurality of second patent document data items, the fifth selected patent document data item not comprising the first keyword data item, wherein the first selection instruction is associated with an unrelated-tag data item, and the third selection instruction is associated with a related-tag data item, wherein the fourth selection instruction is associated with the unrelated-tag data item, wherein the fifth selection instruction is associated with the related-tag data item, wherein the server generates the second search criterion instruction at least on the basis that the first selection instruction is associated with the unrelated-tag data item, that the third selection instruction is associated with the related-tag data item, and that the third selected patent document data item does not comprise the first keyword data item, wherein the server generates the second search criterion instruction at least on the basis that the fourth selection instruction is associated with the unrelated-tag data item, and that the fourth keyword data item is identical to the first keyword data item, wherein the server generates the second search criterion instruction on the basis that the fifth selection instruction is associated with the related-tag data item, and that the fifth selected patent document data item does not comprise the first keyword data item, and wherein none of the plurality of third patent document data items comprises the first keyword data item.

Various aspects and other aspects of the present invention can be better understood with reference to the accompanying drawings and the descriptions of the non-limiting exemplary embodiments given below.

### BRIEF DESCRIPTION OF THE DRAWINGS

FIG. 1 is a system architecture diagram of a patent search system according to an embodiment of the present invention.

FIG. 2A is a schematic view of a search page of the patent search system according to an embodiment of the present invention.

FIG. 2B is a schematic view of a search page of the patent search system according to an embodiment of the present invention.

FIG. 3 is a schematic view of a keyword extraction portion of the server according to an embodiment of the present invention.

FIG. 4 is a schematic view showing a selection of patent document data according to an embodiment of the present invention.

FIG. 5 is a flow chart showing the patent search method according to an embodiment of the present invention.

FIG. 6A is a schematic view showing the server obtaining keyword data from the selected patent document data.

FIG. 6B is a schematic view showing the server obtaining keyword data from the selected patent document data.

### DETAILED DESCRIPTION

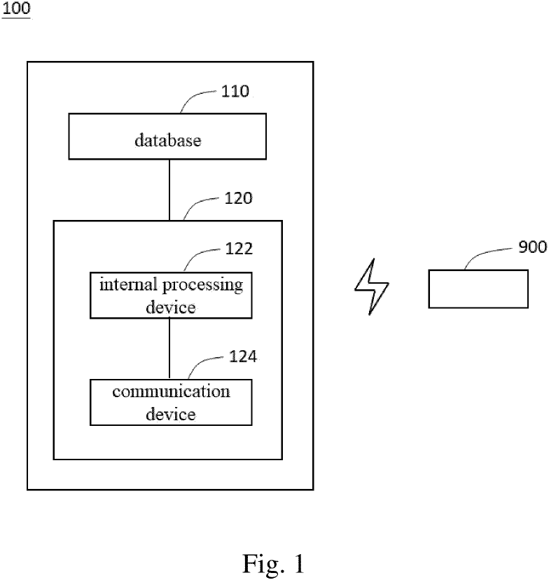

Referring to FIG. 1, a system architecture diagram of a patent search system according to an embodiment of the present invention is provided. As shown in FIG. 1, a patent search system 100 comprises a database 110 and a server 120. The sever 120 has access to (or is communicatively connected) the database 110, and the server 120 can be communicatively connected to one or more user devices 900. In particular, the user device 900 may be, but is not limited thereto, a computer, a tablet computer, a mobile device, and so on, and the user device 900 may comprise a display unit (e.g., a display screen). In this light, the server 120 can, via the display unit of the user device 900, display various data or instructions for the user to view. In one embodiment, the serve 120 is communicatively connected to the user device 900 via a network (e.g., wired network or wireless network, etc.). In one embodiment, the patent search system 100 of the present invention comprises one or more processors, and the patent search system 100 implements functions of the database 110 and/or the server 120 by enabling coordination between the hardware and software. In one embodiment, the server device 900 can comprise one or more processors, and the user device 900 can transmit, receive, and process various data or instructions by enabling coordination between the hardware and software.

In one embodiment, the server 120 can comprise an internal processing device 122 and a communication device 124; the internal processing device 122 is communicatively connected to the communication device 124 and the database 110; the database 110 is communicatively connected to the communication device 124, and the server 120 can be communicatively connected to the user device 900 through the communication device 124. In particular, the server 120 receives various data or instructions from the user device 900 through the communication device 124, and the server 120 transmits various data or instructions to the user device 900 through the communication device 124. In addition, the server 120 processes various data or instructions through the internal processing device 122. Preferably, the server 120 comprises one or more processors, and the server 120 implements functions of the internal processing device 122 and/or the communication device 124 by enabling coordination between the hardware and software.

In the embodiment shown in FIG. 1, the database 110 stores a plurality of first patent document data items (or may be referred to as a first patent document data group). Preferably, the plurality of first patent document data items may include, but are not limited to, patent documents of different countries or different fields. The server 120 can receive a first search criterion instruction provided by the user, and further retrieve a plurality of second patent document data items (or may be referred to as a second patent document data group) from the plurality of first patent document data items based on the first search criterion instruction. In particular, the first search criterion instruction indicates a search criterion, and the server 120 retrieves the plurality of second patent document data items from the plurality of first patent document data items based on the condition that all of the plurality of second patent document data items meet the first search criterion. Next, the server 120 can transmit the retrieved results (i.e., the plurality of second patent document data items) to the user device 900, and can, through the display unit of the user device 900, display the retrieved results for the user to view. The user can read one or more patent document data items (or may be referred to as one or more selected patent document data items) in the plurality of second patent document data items, and separately give a corresponding selection instruction to each of the one or more selected patent document data items. In particular, each of the selection instructions indicates whether the corresponding selected patent document data item is a related patent (i.e., a patent needed by the user) or an unrelated patent (i.e., not a patent needed by the user). In one embodiment, a selection instruction associated with a selected patent document data item can be associated with a related-tag data item or an unrelated-tag data item, wherein the related-tag data item indicates that the selected patent document data item is a patent needed by the user or a patent considered relevant by the user, while the unrelated-tag data item indicates that the selected patent document data item is not a patent needed by the user or considered irrelevant by the user.

The server 120 can obtain a keyword data item from the one or more selected patent document data items based on the one or more selected patent document data items and their respectively corresponding selection instruction. In addition, the server 120 can generate a second search criterion instruction at least based on the first search criterion instruction and the obtained keyword data item, wherein the second search criterion instruction comprises the obtained keyword data item. Next, the server 120 can retrieve a plurality of third patent document data items (or may be referred to as a third patent document data group) from the plurality of first patent document data items based on the second search criterion instruction. Preferably, the second search criterion instruction indicates a second search criterion, and the server 120 retrieves the plurality of third patent document data items from the first patent document data items based on the condition that all of the plurality of third patent document data items meet the second search criterion. Preferably, the second search criterion comprises the first search criterion. In one embodiment, a keyword data item in the second search criterion instruction is used to retrieve a plurality of patent document data items that comprise the keyword data item from the plurality of first patent document data items (a patent document data item that comprises the keyword data item referred to herein shall mean that the patent document contains a word or a phrase identical to the keyword). In one embodiment, a keyword data item in the second search criterion instruction is used to retrieve a plurality of patent document data items that do not include the keyword data item from the plurality of first patent document data items.

In one embodiment, the first search criterion instruction comprises the initial keyword data item provided by the user, and the server 120 retrieves a plurality of second patent document data items from the plurality of first patent document data items based on the first search criterion instruction, wherein the plurality of second patent document data items all comprise the initial keyword data item. In one embodiment, the first search criterion instruction comprises the initial keyword data item provided by the user, and the server 120 retrieves a plurality of second patent document data items as well as a plurality of fourth patent document data items (or may be referred to as a fourth patent document data group) from the plurality of first patent document data items based on the first search criterion instruction, wherein each of the plurality of second patent document data items comprises a data item of invention title, a data item of abstract, a data item of description, and a data item of patent claim, and one of the data item of invention title, the data item of abstract, and the data item of patent claim corresponding to each of the plurality of second patent documents comprises the initial keyword data item, and the plurality of fourth patent document data items all comprise the initial keyword data item. In other words, if one of the invention title data item, the abstract data item, and the patent claim data item of a patent document data item comprises the initial keyword data item, the server 120 would specify such data item as the second patent document data item. If a patent document data item comprises an initial keyword data item, but none of the invention title data item, abstract data item, and patent claim data item of the patent document data item comprises the initial keyword data item, the server 120 would specify it as the fourth patent document data item. One should bear in mind that, since it is more likely that the second patent document data item is a related patent (i.e., a patent needed by the user), when retrieved results of the first search criterion instruction (i.e., the plurality of second patent document data items and the plurality of fourth patent document data items) are displayed for the user to view, the server 120 can display the plurality of second patent document data items in a more conspicuous place, may include, but is not limited to, arranging the plurality of second patent document data items in a front section, and arranging the plurality of fourth patent document data items in the back section. Preferably, different search results are provided according to different situations for the user to view and select by ticking. In one embodiment, when the user wishes to conduct a precision measurement, the server can, based on the first search criterion instruction, provide the plurality of second patent document data items for the user to view and select by ticking. When the user wishes to conduct a recall measurement, the server can, based on the first search criterion instruction, provide the plurality of second patent document data items and the plurality of fourth patent document data items for the user to view and select by ticking.

In one embodiment, the server 120 receives a first selection instruction provided by the user, and the first selection instruction is associated with a first selected patent document data item among the plurality of second patent document data items. The server 120 also obtains the first keyword data item from the first selected patent document data item based on the first selection instruction. Next, the server 120 can generate the second search criterion instruction at least based on the first search criterion instruction and the first keyword data item, and the second search criterion instruction comprises the first keyword data item. The server 120 also retrieves a plurality of third patent document data items from the plurality of first patent document data items based on the second search criterion instruction. In one embodiment, the first selection instruction is associated with the related-tag data item (e.g., the first selection instruction can comprise the related-tag data item), and each of the plurality of third patent document data items retrieved by the server 120 comprises the first keyword data item. In one embodiment, before the server 120 retrieves a plurality of third patent document data items, the server 120 can provide the second search criterion instruction for the user to view and confirm, and allow the user to decide whether or not the various keywords within the second search criterion instruction shall be retained. In this light, when the server 120 obtains multiple keyword data item according to the selected patent document and the corresponding selection instruction, it can allow the user to further confirm which keywords are suitable to be used as the keywords within the search criterion instruction, based on which the user can progress into the next round of search. For example, the user can, before the server 120 retrieves a plurality of third patent document data items, provide a deletion instruction to the server 120, so that the server 120 can delete the first keyword data item from the second search criterion instruction based on the deletion instruction.

In one embodiment, the server 120 receives a first selection instruction provided by the user, and the first selection instruction is associated with a first selected document data item among the plurality of second patent document data items, and the first selection instruction is associated with a related-tag data item, wherein the first selected patent document data item comprises a patent classification data item. The server 120 can obtain the first keyword data item from the first selected patent document data item based on the first selection instruction, and the server 120 can generate the second search criterion instruction at least based on the first search criterion instruction, the first keyword data item, as well as the patent classification data item, wherein the second search criterion instruction comprises the first keyword data item and the patent classification data item. The server 120 can also retrieve a plurality of third patent document data items from the plurality of first patent document data items based on the second search criterion instruction, wherein each of the plurality of third patent document data items retrieved by the server 120 comprises the first keyword data item and the patent classification data item of the first selected patent document data item. The above-mentioned patent classification data item may be, but is not limited thereto, the International Patent Classification (IPC), the Cooperative Patent Classification (CPC), or the United States Patent Classification (UPC), and so on. Preferably, the patent classification data item is a hierarchical patent classification data item (i.e., the patent classification data item adopts a hierarchical classification approach to classify each of the patent document data item). In a different embodiment, the patent classification data item at least comprises the first-level patent classification data item, the second-level patent classification data item, the third-level patent classification data item, and the fourth-level patent classification. In a different embodiment, the patent classification data item at least comprises the first-level patent classification data item, the second-level patent classification data item, the third-level classification data item, the fourth-level patent classification, and the fifth-level patent classification. In a different embodiment, the patent classification data item of the first selected patent document data item shall mean one of the second-level patent classification data item, the third-level patent classification data item, the fourth-level classification data item, and the fifth-level patent classification data item.

In one embodiment, the server 120 receives the first selection instruction and the second selection instruction provided by the user. The first selection instruction is associated with a first selected patent document data item among a plurality of second patent document data items, while the second selection instruction is associated with a second selected patent document data item among a plurality of second patent document data items, wherein the first selection instruction and the second selection instruction are both associated with the related-tag data item. The server 120 can obtain the first keyword data item from the first selected patent document data item based on the first selection instruction. The server 120 can also obtain a second keyword data item from the second selected patent document data item based on the second selection instruction, wherein the second keyword data item is identical to the first keyword data item. The server 120 can generate the second search criterion instruction at least based on the first search criterion instruction, the first keyword data item, and the second keyword data item. The server 120 can also generate the second search criterion instruction at least on the basis that the first keyword data item is identical to the second keyword data item. The plurality of third patent document data items that the server 120 retrieves based on the second search criterion instruction all comprise the first keyword data item.

In one embodiment, the server 120 receives the first selection instruction and the third selection instruction provided by the user. The first selection instruction is associated with the unrelated-tag data item, and the third selection instruction is associated with the related-tag data item. The first selection instruction is associated with the plurality of a first selected patent document data item among the plurality of second document data items, and the third selection instruction is associated with the third selected patent document data item among the plurality of second patent document data items. The server 120 can obtain the first keyword data item from the first selected patent document data item based on the first selection instruction, wherein the third selection patent document data item does not comprise the first keyword data item. The server 120 can generate the second search criterion instruction at least based on the first search criterion instruction and the first keyword data item. The server 120 can also generate the second search criterion instruction at least on the basis that the first selection instruction is associated with the unrelated-tag data item, the third selection instruction is associated with the related-tag data item, and the third selected patent document data item does not comprise the first keyword data item. None of the plurality of third patent document data items retrieved by the server 120 based on the second search criterion instruction comprises the first keyword data item.

Following the foregoing embodiment, in another embodiment, the server 120 receives the fourth selection instruction provided by the user, and the fourth selection instruction is associated with a fourth selected patent document data item among the plurality of second patent document data items, with the fourth selection instruction being associated with the unrelated-tag data item. The server 120 obtains a fourth keyword data item from the fourth selected patent document data item based on the fourth selection instruction, and the fourth keyword data item is identical to the first keyword data item, wherein the server 120 generates the second search criterion instruction at least on the basis that the fourth selection instruction is associated with the unrelated-tag data item, and the fourth keyword is identical to the first keyword data item. None of the plurality of third patent document data items retrieved by the server 120 based on the second search criterion instruction comprises the first keyword data item.

Following the foregoing embodiment, in another embodiment, the server 120 receives the fifth selection instruction provided by the user. The fifth selection instruction is associated with the fifth selected patent document data item among the plurality of second patent document data items, and the fifth selected patent document data item does not comprise the first keyword data item, wherein the fifth selection instruction is associated with the related-tag data item, and the server 120 generates the second search criterion instruction at least on the basis that the fifth selection instruction is associated with the related-tag data item, and the fifth selected patent document data item does not comprise the first keyword data item. In addition, in another embodiment, the server 120 can obtain a third keyword data item from the third selected patent document data item based on the third selection instruction. The server 120 can also obtain a fifth keyword data item from the fifth selected patent document based on the fifth selection instruction, wherein the third keyword data item is identical to the fifth keyword data item, and the server 120 generates the second search criterion instruction at least based on the first search criterion instruction, the third keyword data item, as well as the fifth keyword data item, with the server generating the second search criterion instruction at least on the basis that the third keyword data item is identical to the fifth keyword data item, and the second search criterion instruction does not comprise the third keyword data item. In particular, the plurality of third patent document data items retrieved by the server 120 based on the second search criterion instruction all comprise the third keyword data item (that the plurality of third patent document data items all comprise the third keyword data item, as described herein, shall mean all of the plurality of third patent document data items comprise the keyword data item that is identical to the third keyword data item).

In one embodiment, the server 120 obtains (or extracts) the keyword data item from the selected patent document data item in a manner of semantic analysis, wherein the described semantic analysis can be a semantic analysis method in the prior art, and will not be discussed in detail. In one embodiment, the database 110 stores the keyword data item corresponding to each of the patent document data item (each patent document data item can comprise one or more corresponding keyword data item), and the server 120 can fetch directly from the database 110 the keyword data item corresponding to certain selected patent document data item. In one embodiment, if all of the selected patent document data item associated with the related-tag data item comprise a certain keyword data item, the server 120 of the patent search system 100 can enlist the certain keyword data item as keyword data item suggested to be narrowed (i.e., to be combined with the logical operator “and” in the search). If all of the selected patent document data item associated with the unrelated-tag data item comprise a certain keyword data item, and none of the selected patent document data item associated with the related-tag data item comprises the certain keyword data item, the server 120 could enlist the certain keyword data item as keyword data item suggested to be excluded (i.e., to be combined with logical operator “not” in the search).

The keyword described above can be a key word or a key phrase. Moreover, the first search criterion instruction may include, but is not limited to, a keyword and/or patent national name and/or patent classification number. One should bear in mind that, in its course of assisting the user’s patent search, the patent search system 100 of the present invention can gradually narrow down the number of targeted patent groups through one or more rounds of searches. For example, with the first-round search results, the user can separately associate one or more selection instructions (each selection instruction can comprise the related-tag data item or the unrelated-tag data item) with the one or more selected patent document data item among the search results, and the server can generate the next-round search criterion instruction (the second search criterion instruction) and the corresponding search results (the second search results) based on the one or more selection instructions and the corresponding one or more selected patent document data items. Next, with the second search results the user can repeat the foregoing procedures to obtain the third search results, and can repeat the foregoing procedures toward the third search results to obtain the fourth search results, and so on. The repletion can cease until the number of the subject patent document has the need of the user.

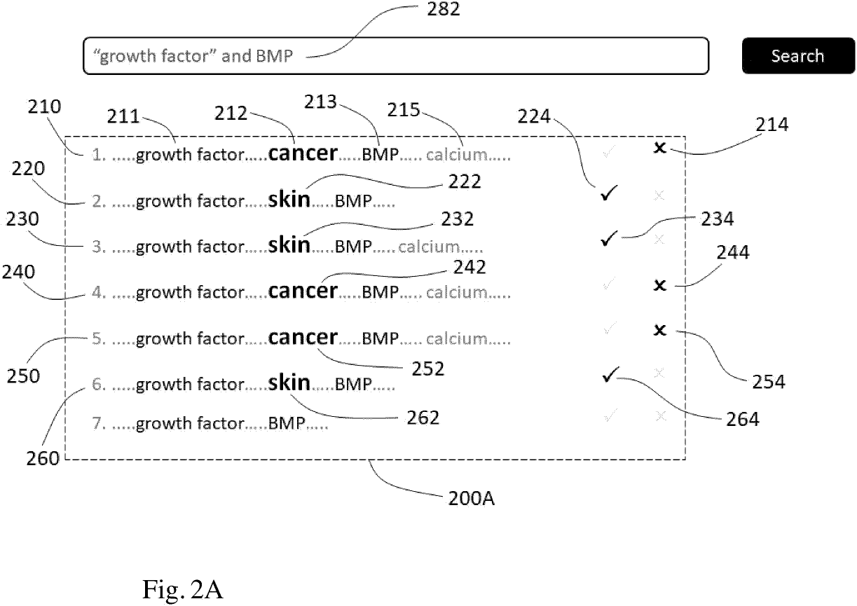

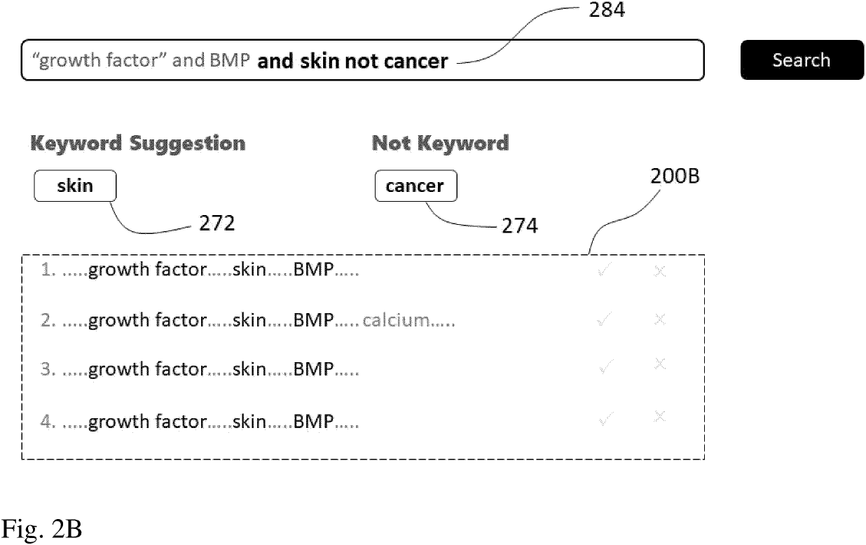

FIGS. 2A and 2B are schematic views of a search page of the patent search system according to an embodiment of the present invention. As shown in FIG. 2A, the search page of the patent search system according to the present invention can display a second patent document data group 200A retrieved by the patent search system based on a first patent search criterion instruction 282 (the second patent document data group 200A includes a plurality of second patent document data items). The second patent document data group 200A comprises selected patent document data items 210, 220, 230, 240, 250, and 260, wherein the selected patent document data item 210 comprises a keyword data item 212, the selected patent document data item 220 comprises a keyword data item 222, the selected patent document data item 230 comprises a keyword data item 232, the selected patent document data item 240 comprises a keyword data item 242, the selected patent document data item 250 comprises a keyword data item 252, and the selected patent document data item 260 comprises a keyword data item 262. The selected patent document data items 223, 230, and 260 respectively comprise selection instructions 224, 234, and 224 that are associated with related-tag data items; the selected patent document data items 210, 240, and 250 respectively comprise selection instructions 214, 244, and 245 that are associated with unrelated-tag data items. In particular, the keyword data items 222, 232, and 262 are identical keyword data items (i.e., they all contain the keyword data item of “skin”), the keyword data items 212, 242, and 252 are identical keyword data items (i.e., they all contain the keyword data item of “cancer”), and none of the selected patent document data items 220, 230, and 260 comprises the keyword data item of “cancer.” Moreover, each of the selected patent document data items 210, 220, 230, 240, 250, and 260 comprises not only one keyword data item, but one or more keyword data items. For example, the selected patent document data item 210 comprises keyword data items 211, 213, and 215.

As shown in FIG. 2B, the patent search system of the present invention can list a keyword data item 272 as a suggested keyword data item for narrowing down the search (i.e., to suggest that the keyword data item of “skin” be used jointly with the logical operator “and”) based on the condition that the selected patent document data items 220, 230, and 260 all comprise the keyword data item of “skin.” In addition, the patent search system can list a keyword data item 274 as a suggested keyword data item to be excluded in the search (i.e., to suggest that the keyword data item of “cancer” be used jointly with the logical operator “not”) based on the condition that the selected patent document data items 210, 240, and 250 all comprise the keyword data item of “cancer,” while none of the selected patent document data items 220, 230, and 260 comprises the keyword data item of “cancer.” The patent search system can generate a second search criterion instruction 284 based on the first search criterion 282, the keyword data item of “cancer,” and the keyword data item of “skin.” Then, the patent search system of the present invention can, based on the second search criterion instruction 284, retrieve a third patent document data group 200B (the third patent document data group 200B includes a plurality of third patent document data items). Each of the patent document data item in the third patent document data group 200B comprises the keyword data of “skin,” and none of the patent document data items in the third patent document data group 200B comprises the keyword data item of “cancer.”

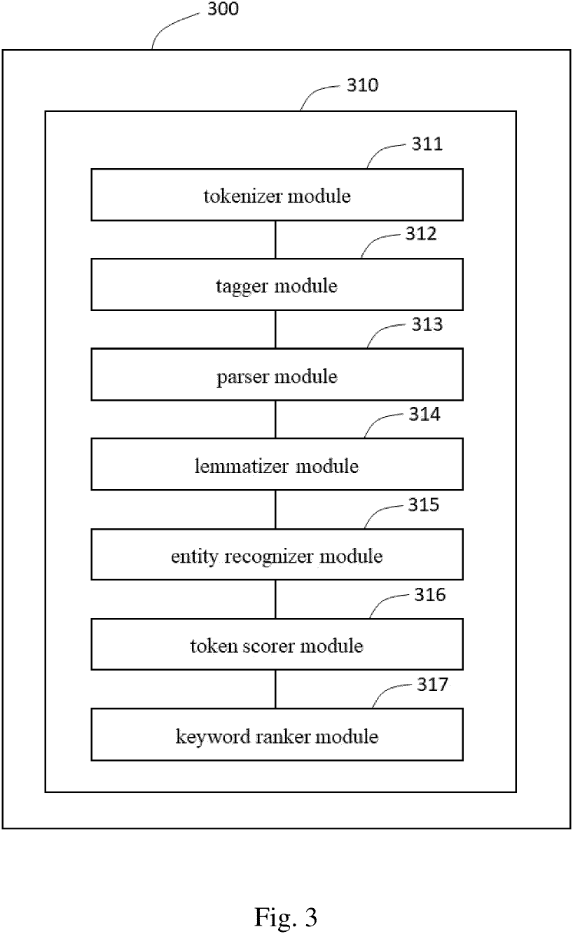

Referring to FIG. 3, a schematic view of an embodiment of the keyword extracting portion of the server is provided. As shown in the embodiment in FIG. 3, the server 300 of the patent search system of the present invention comprises a keyword extracting portion 310. The keyword extracting portion 310 comprises a tokenizer module 311, a tagger module 312, a parser module 313, a lemmatizer module 314, an entity recognizer module 315, a token scorer module 316, and a keyword ranker module 317, wherein the tokenizer module 311 is communicatively connected to the tagger module 312; the tagger module 312 is communicatively connected to the parser module 313; the parser module 313 is communicatively connected to the lemmatizer module 314; the lemmatizer module 314 is communicatively connected to the entity recognizer module 315; the entity recognizer module 315 is communicatively connected to the token scorer module 316; the token scorer module 316 is communicatively connected to the keyword ranker module 317. In one embodiment, the tokenizer module 311, the tagger module 312, the parser module 313, the lemmatizer module 314, the entity recognizer module 315, the token scorer module 316, and the keyword ranker module 317 are communicatively connectable to each other among themselves. In one embodiment, the server 300 of the patent search system of the present invention comprises one or more processors, and the server 300 implements the tokenizer module 311, the tagger module 312, the parser module 313, the lemmatizer module 314, the entity recognizer module 315, the token scorer module 316, and the keyword ranker module 317 by hardware and software collaboration.

The tokenizer module 311 can divide the patent document data items into tokens, which can be further divided into words or phrases. The tagger module 312 can analyze and tag the part of speech (such as a noun, a verb, etc.) to the token. The parser module 313 can analyze the token and the corresponding speech of the token, and can tag the contextual dependency of the tokens to the token. The lemmatizer module 314 can lemmatize a word to the lemma (e.g., to lemmatize “closed” to “close”). The entity recognizer 315 can identify a specifically-named subject (e.g., to identify the “Application Programming Interface” as a specifically-named subject). The token scorer module 316 can use an analytical algorithm method to score or give a corresponding weight to the importance of each token in the patent document data item, wherein the analytical algorithm method may be, but is not limited thereto, the Term Frequency-Inverse Document Frequency (TF-IDF) or the TextRank. The keyword ranker module 317 can rank each token according to the importance score (such as the weighting) and/or a specific condition of the token in order to sort out important keywords within the patent document data item. In particular, the specific condition may be, but is not limited thereto, an additional model prediction or a patent category, and so on.

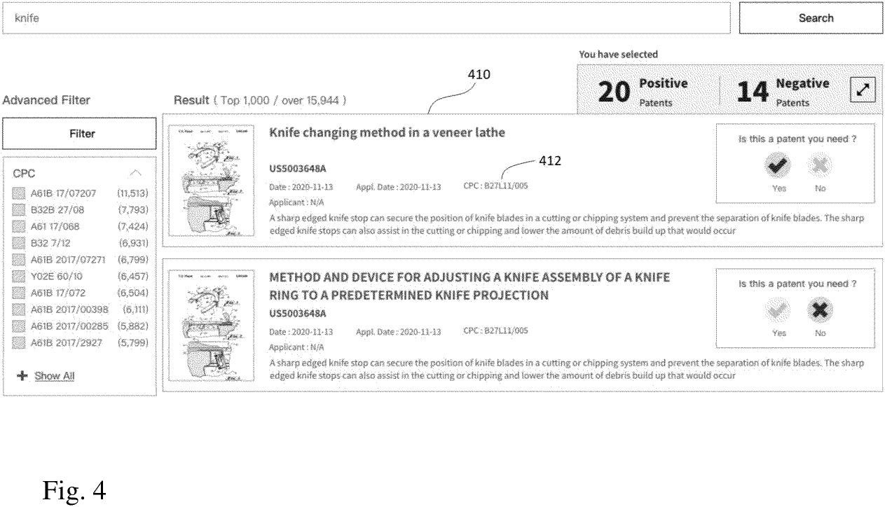

Referring to FIG. 4, a schematic view of an embodiment of the selected patent data item is provided. As shown in the embodiment of FIG. 4, the elected patent document data item 410 can comprise the patent classification data item 412, wherein the patent classification data item 412 comprises the first-level patent classification data item (see “B” of the patent classification data item 412), the second-level patent classification data item (see “B27” of the patent classification data item 412), the third-level patent classification data item (see “B27L” of the patent classification data item 412), the fourth-level patent classification data item (see “B27L11” of the patent classification data item 412), and the fifth-level patent classification data item (see “B27L11/005” of the patent classification data item 412).

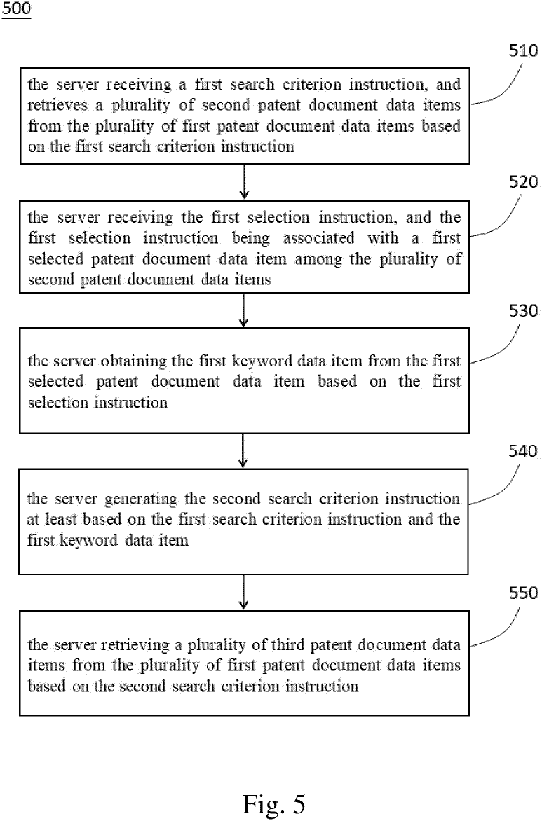

Referring to FIG. 5, a flow diagram of an embodiment of the patent search method of the present invention is provided. As shown in FIG. 5, the patent search method 500 is applied to a patent search system, and the patent search system comprises a database and a server; the database stores a plurality of first patent document data items, and the server has access to the database. The server patent method 500 starts from the step 510, with the server of the patent search system receiving a first search criterion instruction, and retrieves a plurality of second patent document data items from the plurality of first patent document data items based on the first search criterion instruction, wherein the first search criterion instruction indicates a first search criterion, and the server retrieves the plurality of second patent document data items from the plurality of first patent document data items on the basis that the plurality of second patent document data items all meet the first search criterion. Next, the step 520 is performed, with the server receiving the first selection instruction provided by the user, and the first selection instruction being associated with a first selected patent document data item among the plurality of second patent document data items. Next, the step 530 is performed, with the server obtaining the first keyword data item from the first selected patent document data item based on the first selection instruction. Next, the step 540 is performed, with the server generating the second search criterion instruction at least based on the first search criterion instruction and the first keyword data item, wherein the second search criterion instruction comprises the first keyword data item. Next, the step 550 is performed, with the server retrieving a plurality of third patent document data items from the plurality of first patent document data items based on the second search criterion instruction, wherein the second search criterion instruction indicates the second search criterion, and the server retrieves the plurality of third patent document data items from the plurality of first patent document data items on the basis that the plurality of third patent document data items all meet the second search criterion. In one embodiment, the first selection instruction is associated with a related-tag data item, and each of the plurality of third patent document data items comprises the first keyword data item.

In one embodiment, the patent search method 500 further comprises: before the server 120 retrieves a plurality of third patent document data items, the server deletes the first keyword data item from the second search criterion instruction based on the deletion instruction. In one embodiment, the first search criterion instruction comprises an initial keyword data item, and the server retrieves a plurality of second patent document data items and a plurality of fourth patent document data items from the plurality of first patent document data items based on the first search criterion instruction, wherein each of the plurality of second patent document data items comprises an invention title data item, an abstract data item, and a patent claim data item, and one of the title data item, the abstract data item, and the claim data item corresponding to each of the plurality of second patent document data items comprises the initial keyword data item, and each of the plurality of fourth patent document data items comprises the initial keyword data item.

In one embodiment, the first selected patent document data item comprises a patent classification data item, and the first selection instruction is associated with a related-tag data item. The server generates a second search criterion instruction at least based on the first search criterion instruction, the first keyword data item, and the patent classification data item of the first selected patent document data item, and the second search instruction condition comprises the first keyword data item and the patent classification data item, wherein the plurality of third patent document data items retrieved based on the second search criterion instruction all comprise the first keyword data item and the patent classification data item.

In one embodiment, the patent search method 500 further comprises: the server receives the second selection instruction provided by the user, and the second selection instruction is associated with a second selected patent document data item within the plurality of second patent document data items, wherein the first selection instruction and the second selection instruction are both associated with a related-tag data item. The patent search method 500 further comprises: the server obtains the second keyword data item from the second selected patent document data item based on the second selection instruction, and the first keyword data item is identical to the second keyword data item, wherein the server generates the second search criterion instruction at least based on the first search criterion instruction, the first keyword data item, and the second keyword data item, and the server generates the second search criterion instruction at least on the basis that the first keyword data item is identical to the second keyword data item. At the same time, all of the plurality of third patent document data items retrieved by the server comprise the first keyword data item.

In one embodiment, the patent search method 500 further comprises: the server receives the third selection instruction provided by the user, and the third selection instruction is associated with a third selected patent document data item within the plurality of second patent document data items, and the third selected patent document data item does not comprise the first keyword data item, wherein the first selection instruction is associated with an unrelated-tag data item, and the third selection instruction is associated with a related-tag data item. The server generates the second search criterion instruction at least on the basis that the first selection instruction is associated with an unrelated-tag data item, the third selection instruction is associated with a related-tag data item, and the third selected patent document data item does not comprise the first keyword data item. At the same time, all of the plurality of third patent document data items comprise the first keyword data item.

Following the foregoing embodiment, in another embodiment, the patent search method 500 further comprises: the server receives the fourth selection instruction provided by the user, and the fourth selection instruction is associated with a fourth selected patent document data item within the plurality of second patent document data items. The patent search method 500 further comprises: the server obtains a fourth keyword data item from the fourth selected patent document data item based on the fourth selection instruction, and the fourth keyword data item is identical to the first keyword data item, wherein the fourth selection instruction is associated with an unrelated-tag data item, and the server is associated with the unrelated-tag data item as least based on the fourth selection, with fourth keyword data item generating the second search criterion instruction for being identical to the first keyword data item.

Following the foregoing embodiment, in another embodiment, the patent search method 500 further comprises: the server receives the fifth selection instruction provided by the user, and the fifth selection instruction is associated with a fifth selected patent document data item within the plurality of second patent document data items, and the fifth selection patent document data item does not comprise the first keyword data item, wherein the fifth selection instruction generates the second search criterion instruction at least on the basis that the fifth selection instruction is identical to the related-tag data item, and the fifth selected patent document data item does not comprise the fifth first keyword data item.

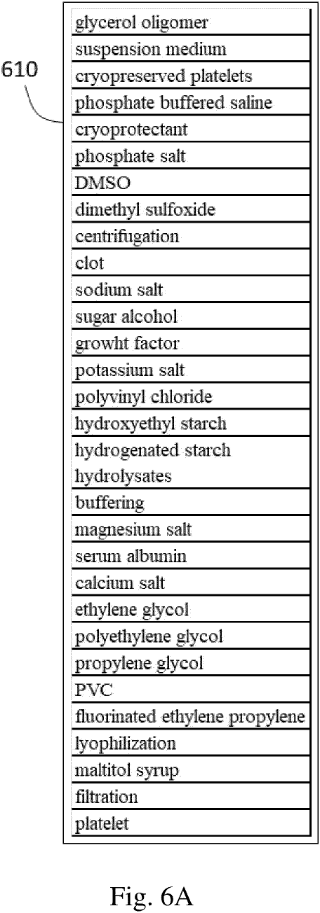

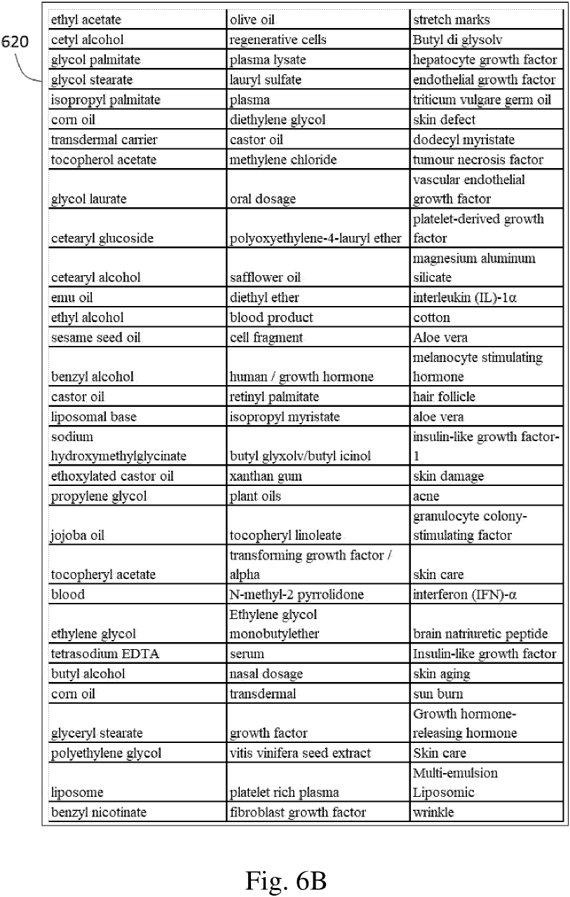

Referring to FIGS. 6A and 6B, they are different embodiments showing schematic views of the server obtaining the keyword data item from the patent document data item. As shown in FIG. 6A, the server of the patent search system of the present invention can obtain (or extract) a plurality of keyword data items from the patent document data item 610. As shown in the embodiment of FIG. 6B, the server of the patent search system of the present invention can obtain (or extract) a plurality of keyword data items from the patent document data item 620. One should bear in mind that, FIGS. 6A and 6B are intended to be examples only, and the keywords extracted by the server are not restricted to the words shown in the examples. In addition, in one embodiment, the server does not merely extract keywords within the patent document data item. Rather, it can extract keywords within each of the patent document data item according to the demand. In another embodiment, the sever can first extract the keyword data item of each of the patent document data item, and then store the keyword data item of each of the patent document data item in the database. By doing so, the server can obtain the corresponding keyword data item from the database based on the selection instruction upon receipt of the selection instruction (which is associated with the specifically selected patent document data item).

At this point, the embodiments and the figures above have illustrated the patent search system and method thereof for the present invention. One should bear in mind that, every embodiment of the present invention is merely for the purpose of exemplification, and a variety of changes and modifications can be made within the scope of the invention without departing from the scope and spirit thereof, and all of the changes and modifications shall be subject to the patent scope of the present invention. Therefore, the embodiments provided herein shall not be construed as limitations to the invention, and patent claims below have disclosed the actual scope and spirit of the present invention.

What is claimed is:

1. A patent search system, comprising:
a database storing a plurality of first patent document data items; and
a server accessing the database, the server receiving a first search criterion instruction and then retrieving a plurality of second patent document data items from the plurality of first patent document data items based on the first search criterion instruction,
wherein the server receives a first selection instruction associated with a first selected patent document data item in the plurality of second patent document data items, obtains a first keyword data item from the first selected patent document data item based on the first selection instruction, and generates a second search criterion instruction at least based on the first search criterion instruction and the first keyword data item, the second search criterion instruction comprising the first keyword data item,
wherein the server retrieves a plurality of third patent document data items from the plurality of first patent document data items based on the second search criterion instruction,
wherein the first search criterion instruction indicates a first search criterion, and the server retrieves the plurality of second patent document data items from the plurality of first patent document data items on the basis that the plurality of second patent document data items all meet the first search criterion, and
wherein the second search criterion instruction indicates a second search criterion, and the server retrieves the plurality of third patent document data items from the plurality of first patent document data items on the basis that the plurality of third patent document data items all meet the second search criterion.

2. The patent search system of claim 1, wherein the first search criterion instruction comprises an initial keyword data item, and the server retrieves the plurality of second patent document data items and a plurality of fourth patent document data items from the plurality of first patent document data items based on the first search criterion instruction,
wherein each of the plurality of second patent document data items comprises an invention title data item, an abstract data item, and a patent claims data item, and one of the invention title data item, the abstract data item, and the patent claims data item corresponding to each of the plurality of second patent document data items comprises the initial keyword data item, and
wherein the plurality of fourth patent document data items all comprise the initial keyword data item.

3. The patent search system of claim 1, wherein the first selection instruction is associated with a related-tag data item, and each of the plurality of third patent document data items comprises the first keyword data item.

4. The patent search system of claim 1, wherein the first selected patent document data item comprises a patent classification data item, and the first selection instruction is associated with a related-tag data item,
wherein the server generates a second search criterion instruction at least based on the first search criterion instruction, the first keyword data item, and the patent classification data item, the second search criterion instruction comprising the patent classification data item, and
wherein the plurality of third patent document data items all comprise the first keyword data item and the patent classification data item.

5. The patent search system of claim 1, wherein prior to retrieving the plurality of third patent document data items, the server deletes the first keyword data item from the second search criterion instruction based on a deletion instruction.

6. The patent search system of claim 1, wherein the server receives a second selection instruction associated with a second selected patent document data item in the plurality of second patent document data items, and obtains a second keyword data item from the second selected patent document data item based on the second selection instruction, the second keyword data item being identical to the first keyword data item,
wherein the server generates the second search criterion instruction at least based on the first search criterion instruction, the first keyword data item, and the second keyword data item, and the server generates the second search criterion instruction at least on the basis that the first keyword data item is identical to the second keyword data item, and
wherein the first selection instruction and the second selection instruction are both associated with a related-tag data item, and the plurality of third patent document data items all comprise the first keyword data item.

7. The patent search system of claim 1, wherein the server receives a third selection instruction associated with a third selected patent document data item in the plurality of second patent document data items, the third selected patent document data item not comprising the first keyword data item,
wherein the first selection instruction is associated with an unrelated-tag data item, and the third selection instruction is associated with a related-tag data item,
wherein the server generates the second search criterion instruction at least on the basis that the first selection instruction is associated with the unrelated-tag data item, that the third selection instruction is associated with the related-tag data item, and that the third selected patent document data item does not comprise the first keyword data item, and
wherein none of the plurality of third patent document data item comprises the first keyword data item.

8. The patent search system of claim 7, wherein the server receives a fourth selection instruction associated with a fourth selected patent document data item in the plurality of second patent document data items, and obtains a fourth keyword data item from the fourth selected patent document data item based on the fourth selection instruction, the fourth keyword data item being identical to the first keyword data item,
wherein the fourth selection instruction is associated with the unrelated-tag data item, and
wherein the server generates the second search criterion instruction at least on the basis that the fourth selection instruction is associated with the unrelated-tag data item, and that the fourth keyword data item is identical to the first keyword data item.

9. The patent search system of claim 8, wherein the server receives a fifth selection instruction associated with a fifth selected patent document data item in the plurality of second patent document data items, the fifth selected patent document data item not comprising the first keyword data item,
wherein the fifth selection instruction is associated with the related-tag data item, and
wherein the server generates the second search criterion instruction at least on the basis that the fifth selection instruction is associated with the related-tag data item, and that the fifth selected patent document data item does not comprise the first keyword data item.

10. A patent search method for use in a patent search system, the patent search system comprising a database and a server, the database storing a plurality of first patent document data items, the server accessing the database, the patent search method comprising the steps of:
receiving, by the server, a first search criterion instruction and retrieving a plurality of second patent document data items from the plurality of first patent document data items based on the first search criterion instruction;
receiving, by the server, a first selection instruction associated with a first selected patent document data item in the plurality of second patent document data items;
obtaining, by the server, a first keyword data item from the first selected patent document data item based on the first selection instruction;
generating, by the server, a second search criterion instruction at least based on the first search criterion instruction and the first keyword data item, the second search criterion instruction comprising the first keyword data item; and
retrieving, by the server, a plurality of third patent document data items from the plurality of first patent document data items based on the second search criterion instruction,
wherein the first search criterion instruction indicates a first search criterion, and the server retrieves the plurality of second patent document data items from the plurality of first patent document data items on the basis that the plurality of second patent document data items all meet the first search criterion, and
wherein the second search criterion instruction indicates a second search criterion, and the server retrieves the plurality of third patent document data items from the plurality of first patent document data items on the basis that the plurality of third patent document data items all meet the second search criterion.

11. The patent search method of claim 10, wherein the first search criterion instruction comprises an initial keyword data item, and the server retrieves the plurality of second patent document data items and a plurality of fourth patent document data items from the plurality of first patent document data items based on the first search criterion instruction,
wherein each of the plurality of second patent document data items comprises an invention title data item, an abstract data item, and a patent claims data item, and one of the invention title data item, the abstract data item, and the patent claims data item corresponding to each of the plurality of second patent document data items comprises the initial keyword data item, and
wherein the plurality of fourth patent document data items all comprise the initial keyword data item.

12. The patent search method of claim 10, wherein the first selection instruction is associated with a related-tag data item, and the plurality of third patent document data items all comprise the first keyword data item.

13. The patent search method of claim 10, wherein the first selected patent document data item comprises a patent classification data item, and the first selection instruction is associated with a related-tag data item,
wherein the server generates a second search criterion instruction at least based on the first search criterion instruction, the first keyword data item, and the patent classification data item, and the second search criterion instruction comprises the patent classification data item, and
wherein the plurality of third patent document data items all comprise the first keyword data item and the patent classification data item.

14. The patent search method of claim 10, further comprising: deleting, by the server, the first keyword data item from the second search criterion instruction based on a deletion instruction prior to retrieving the plurality of third patent document data items.

15. The patent search method of claim 10, further comprising:
receiving, by the server, a second selection instruction associated with a second selected patent document data item in the plurality of second patent document data items; and
obtaining, by the server, a second keyword data item from the second selected patent document data item based on the second selection instruction, the second keyword data item being identical to the first keyword data item,
wherein the server generates the second search criterion instruction at least based on the first search criterion instruction, the first keyword data item, and the second keyword data item, and the server generates the second search criterion instruction at least on the basis that the first keyword data item is identical to the second keyword data item, and
wherein the first selection instruction and the second selection instruction are both associated with a related-tag data item, and the plurality of third patent document data items all comprise the first keyword data item.

16. The patent search method of claim 10, further comprising:
receiving, by the server, a third selection instruction associated with a third selected patent document data item in the plurality of second patent document data items, the third selected patent document data item not comprising the first keyword data item,
wherein the first selection instruction is associated with an unrelated-tag data item, and the third selection instruction is associated with a related-tag data item,
wherein the server generates the second search criterion instruction at least on the basis that the first selection instruction is associated with the unrelated-tag data item, that the third selection instruction is associated with the related-tag data item, and that the third selected patent document data item does not comprise the first keyword data item, and
wherein none of the plurality of third patent document data items comprises the first keyword data item.

17. The patent search method of claim 16, further comprising:
receiving, by the server, a fourth selection instruction associated with a fourth selected patent document data item in the plurality of second patent document data items; and
obtaining, by the server, a fourth keyword data item from the fourth selected patent document data item based on the fourth selection instruction, the fourth keyword data item being identical to the first keyword data item,
wherein the fourth selection instruction is associated with the unrelated-tag data item, and
wherein the server generates the second search criterion instruction at least on the basis that the fourth selection instruction is associated with the unrelated-tag data item, and that the fourth keyword data item is identical to the first keyword data item.

18. The patent search method of claim 17, further comprising:
receiving, by the server, a fifth selection instruction associated with a fifth selected patent document data item in the plurality of second patent document data items, the fifth selected patent document data item not comprising the first keyword data item,
wherein the fifth selection instruction is associated with the related-tag data item, and
wherein the server generates the second search criterion instruction on the basis that the fifth selection instruction is associated with the related-tag data item, and that the fifth selected patent document data item does not comprise the first keyword data item.
